(19) United States
(12) Patent Application Publication
(10) Pub. No.: US 2023/0255226 A1
(43) Pub. Date: Aug. 17, 2023

(54) IRON FORTIFIED TEA-BASED BEVERAGE

(71) Applicant: EKATERRA TEA MANUFACTURING USA LLC, Wilmington, DE (US)

(72) Inventors: Monique Cecilia Desire VAN DER BURG-KOOREVAAR, Ede (NL); Gustaaf Servaas Marie Joseph Emile DUCHATEAU, Hellevoetsluis (NL); Krassimir Petkov VELIKOV, Utrecht (NL)

(21) Appl. No.: 18/009,430

(22) PCT Filed: Apr. 22, 2021
(86) PCT No.: PCT/EP2021/060588

§ 371 Date: Dec. 9, 2022

(30) Foreign Application Priority Data
Jun. 19, 2020 (EP) 20181088.4

(51) Int. Cl. A23F 3/14; A23L 33/165

(52) U.S. Cl. CPC A23F 3/14; A23L 33/165

(57) ABSTRACT

The present invention provides a product comprising: a) a tea component, b) FeNaEDTA; and c) di-basic NaPP.

### TECHNICAL FIELD OF THE INVENTION

The present invention is directed to the provision of healthy and consumer acceptable beverages. In particular, it is directed to tea-based beverages that contain iron but that do not suffer from colour changes or darkening typically associated with the presence of iron in such beverages.

### BACKGROUND TO THE INVENTION

Iron deficiency is common in the population. The CODEX Alimentarius of the World Health Organisation states a Nutrient Reference Value (NRV) of 22 mg of iron for diets rich in plant foods (such as those mainly consumed in India). However, more than a sixth of the global population is known to suffer from nutritional iron deficiencies. Anaemia is a common result of iron deficiency.

Fortification of food with iron is one way of providing iron to deficient populations. This is particularly required in countries such as India where the average iron intake is only 50-80% of the recommended dietary intake. Further, in India this iron is only available as non-haem iron as a large section of the population of the country is vegetarian.

Common sources of iron used for fortification of food and beverages include ferrous sulphate, ferrous lactate, ferrous gluconate and ferrous citrate. Iron in the soluble form is preferred as non-soluble or slightly soluble iron sources like elemental iron and some ferric salts show poor bioavailability.

Tea is a popular, cheaply available beverage consumed throughout the world. Fortifying tea with iron compounds would therefore be an excellent way of providing iron. However, fortification of tea with a soluble iron source is a well known problem because the polyphenols present in tea complex with iron compounds to form insoluble iron-polyphenol complexes that are dark in colour. These complexes form during the preparation of the tea beverages and the tea liquor produced is therefore darker and has a different colour to non-fortified tea. Such organoleptic changes caused by fortifying teas with iron are not acceptable to consumers and therefore solutions to this problem have been sought previously.

US2003031757 relates to beverages, including powdered beverage mixes, fortified with allegedly stable and bioavailable iron. Tea-based beverages are not mentioned. US2003031757 alleges that the iron in ferric EDTA does not appreciably interchange with other cations often present in a beverage formulation with added vitamin/mineral mixes (e.g., sodium, calcium, potassium, zinc, iodine, vitamin C, vitamin E, and the like). As a consequence, it is alleged, no significant free iron is generated in solution to be available to react and form off-flavors or colors. It is asserted in US2003031757 that ferric EDTA chelates the iron sufficiently to render it unavailable for reactivity, even in relatively dilute aqueous forms.

In Dueik et al. it is alleged that the effect of inhibitors of iron absorption can be avoided by using protected iron fortification compounds such as ferric sodium EDTA. It is alleged that iron in this form is stable, highly bioavailable, and not affected by preparation conditions and has fewer undesirable effects, such as rancidity and organoleptic problems, than other water-soluble fortificants. See: Dueik, V., Chen, B. K., & Diosady, L. L. (2017). Iron-polyphenol interaction reduces iron bioavailability in fortified tea: Competing complexation to ensure iron bioavailability. Journal of Food Quality, 2017 doi:10.1155/2017/1805047.

McGee et al. discloses that fortifying black tea with iron has the potential to reduce the incidence of iron deficiency in the developing world. However, maintaining iron bioavailability and visual appeal presents a serious technical challenge due to the formation of iron-polyphenol complexes. In this disclosure, the validity of using competing complexing agents to prevent the formation of iron-polyphenol complexes in iron fortified black tea was studied. Disodium EDTA was alleged to be the most successful and was optimized to a 1:2 iron:EDTA molar ratio. See: McGee, E. J. T., & Diosady, L. L. (2018). Prevention of iron-polyphenol complex formation by chelation in black tea. LWT—Food Science and Technology, 89, 756-762. doi:10.1016/j.Iwt.2017.11.041.

US2018279638 relates to methods of fortifying tea with iron to provide a fortified tea product that is alleged to be an inexpensive source of bioavailable dietary iron. As well, the disclosure relates to iron-fortified tea beverages in which iron is allegedly bioavailable. It also discloses that iron fortification is often associated with undesirable flavour and colour changes in the food due to reaction of components of the food with the iron. To address the issue of reduced bioavailability of iron when added to tea, and the resulting reduction in bioavailable polyphenols, the disclosure uses competitive chelation to counteract the complexing effects of the polyphenols in the tea on the added iron. A disclosed iron-fortified tea preparation comprises dried tea having an adhered chelator/iron mixture, with the chelator:iron molar ratio in the mixture being about 2:1 or greater. The chelator may have a molecular weight of 1000 daltons or less, and may be, for example, EDTA or EDDHA, or a combination thereof. In some embodiments, the chelator is EDTA.

However, as described further below, FeNaEDTA (a combination of Iron, Sodium, and an EDTA chelator) nevertheless still causes an undesired darkening and change in the colour of tea-based beverages to which it is added.

### SUMMARY OF INVENTION

The present inventors have now found that it is possible to fortify tea-based beverages using FeNaEDTA as an iron source. Although FeNaEDTA typically causes organoleptic issues including an undesirable darkening of the brewed product, the inventors have now found that if the FeNaEDTA is provided in combination with di-basic sodium pyrophosphate (di-basic NaPP) then the resultant brewed product does not suffer from darkening or other colour changes normally associated with fortification using FeNaEDTA.

The FeNaEDTA and di-basic NaPP can be incorporated during the process of tea manufacture. They may also be used in leaf-based beverage products, ready to drink formats, water soluble tea powders or granules, or liquid tea beverages.

The tea liquor obtained has good colour and clarity, it is fortified with iron, and it has and none of the darkening, colour changes, or other poor visual and sensory attributes associated with iron fortified teas.

The invention therefore provides a product comprising:
a) a tea component,
b) FeNaEDTA; and
c) di-basic NaPP.

Preferably, the product is a beverage precursor. That is to say, the product comprises a tea component from which a tea based beverage is prepared. The tea component is preferably tea leaves to be brewed, or tea powder to be dissolved, or tea granules to be dissolved.

Preferably, the tea component is derived from the plant Camellia sinensis.

Preferably, the tea component is green tea or black tea.

More preferably, the tea component is black tea.

Alternatively, the tea component is green tea.

The tea component may be leaf tea, or tea extract, or tea powder, or tea granules

Preferably, the tea component is leaf tea.

More preferably, the tea component is black leaf tea.

Alternatively, the tea component is green leaf tea.

Preferably the product comprises from 90 to 99.9% by dry weight of the tea component, more preferably from 92 to 99.75%, more preferably still from 94 to 99.5%, yet more preferably from 96 to 99.25%, most preferably from 98 to 99% by dry weight of the tea component.

Preferably the product comprises from 0.05 to 10% by dry weight of FeNaEDTA, more preferably from 0.1 to 7.5%, more preferably still from 0.2 to 5%, yet more preferably from 0.3 to 2.5%, yet more preferably still from 0.5 to 1%, most preferably from 0.6 to 0.7% by dry weight of FeNaEDTA.

Preferably the product comprises from 0.05 to 10% by dry weight of di-basic NaPP, more preferably from 0.1 to 7.5%, more preferably still from 0.2 to 5%, yet more preferably from 0.3 to 2.5%, yet more preferably still from 0.5 to 1%, most preferably from 0.8 to 0.9% by dry weight of di-basic NaPP.

Preferably the product comprises a molar ratio of di-basic NaPP:FeNaEDTA of from 0.5:1 to 4:1, more preferably from 0.75:1 to 3.5:1, more preferably still from 1:1 to 3:1, yet more preferably from 1.5:1 to 2.5:1, most preferably about 2:1.

### DETAILED DESCRIPTION OF THE INVENTION

### Product

The present invention relates to an iron fortified product comprising a tea component. The product of the invention encompasses ready-to-drink teas including bottled tea-based beverages such as iced tea, leaf-based beverage products, ready to drink formats, water soluble tea powders or granules, or liquid tea beverages.

The invention is particularly directed towards beverage precursor products—that is to say, products in which tea is provided in a dry format to which water will be added by the consumer. The tea component may therefore be tea leaves to be brewed, or tea powder to be dissolved, or tea granules to be dissolved, or a combination thereof.

### Tea Component

For the purpose of the present invention, “tea” means material from Camellia sinensis var. sinensis and/or Camellia sinensis var. assamica. The term “leaf tea” refers to leaf and/or stem material from the tea plant in an uninfused form (i.e. material which has not been subjected to a solvent extraction step). In other words, the term “leaf tea” refers to the end product of tea manufacture (sometimes referred to as “made tea”).

As used herein, the term “black tea” refers to substantially fermented tea, wherein “fermentation” refers to the oxidative and hydrolytic process that tea undergoes when certain endogenous enzymes and substrates are brought together. During the so-called fermentation process, colourless catechins in the leaves and/or stem are converted to a complex mixture of yellow/orange to dark brown polyphenolic substances. For example, black leaf tea can be manufactured from fresh tea material by the steps of: withering, maceration, fermentation and drying. A more detailed description of the production of black tea can be found in Chapter 14 of “Tea: Cultivation to consumption” (edited by K. C. Wilson & M. N. Clifford, published in 1992).

The tea component of the present invention may therefore be derived from the plant Camellia sinensis. The tea component may be green tea or black tea. The tea component may be leaf tea, or tea extract, or tea powder. It is preferred that the tea component is leaf tea. More preferably, the tea component is black leaf tea or green leaf tea.

In order to deliver the organoleptic profile expected of a tea-based beverage, the required levels of polyphenols, or both, the product may comprise from 90 to 99.9% by dry weight of the tea component, more preferably from 92 to 99.75%, more preferably still from 94 to 99.5%, yet more preferably from 96 to 99.25%, most preferably from 98 to 99% by dry weight of the tea component.

The product may comprise from 0.5 g to 10 g of the tea component per portion, more preferably from 1 g to 7.5 g, more preferably still from 1.5 g to 5 g, most preferably about 2 g of the tea component per portion.

As used herein, the term “portion” means the amount of the product required for a single serving. In the case of ready to drink products, a portion will typically be a bottle or can of from 200 to 300 ml. For beverage precursor products (that is to say, products in which tea is provided in a dry format to which water will be added by the consumer), a portion is the amount of the beverage precursor product that is required to make the drink.

### Iron Source

The product of the invention is fortified with Iron. Specifically, it is fortified with FeNaEDTA.

FeNaEDTA has the CAS number 15708-41-5, formula C₁₀H₁₂N₂O₈FeNa, and the following structure:

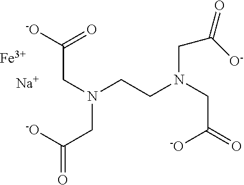

Synonyms of FeNaEDTA include: Iron(III) sodium EDTA; Ferric Sodium EDTA; Ethylenediaminetetraacetic Acid, Ferric-Sodium Salt; FeNa-EDTA; sodium iron(III) EDTA; Ferrazone; and Sodium feredetate.

As stated, thanks to the present invention the product is able to provide high levels of iron fortification without suffering from darkening or colour change. The product may therefore comprise from 0.05 to 10% by dry weight of FeNaEDTA, more preferably from 0.1 to 7.5%, more preferably still from 0.2 to 5%, yet more preferably from 0.3 to 2.5%, yet more preferably still from 0.5 to 1%, most preferably from 0.6 to 0.7% by dry weight of FeNaEDTA.

The product may comprise from 0.5 to 100 mg of FeNaEDTA per portion, more preferably from 1 to 75 mg, more preferably still from 2.5 to 50 mg, yet more preferably from 5 to 25 mg, yet more preferably still from 7.5 to 20 mg, most preferably from 10 to 15 mg of FeNaEDTA per portion.

The CODEX Alimentarius of the World Health Organisation states a Nutrient Reference Value (NRV) of 22 mg of Iron for diets rich in plant foods (such as those mainly consumed in India). Due to the presence of the colour corrector, the product may comprise high levels of iron without suffering darkening or colour change. The product may therefore comprise from 1 to 50% of the aforementioned NRV of iron per portion, preferably from 2 to 35%, more preferably from 5 to 20%, more preferably still from 7.5 to 15%, most preferably about 10% of the NRV of iron per portion.

The product may comprise from 0.2 mg to 10 mg iron per portion, preferably from 0.5 mg to 7.5 mg, more preferably from 1 mg to 5 mg, more preferably still from 1.5 to 4 mg. Most preferably, the product comprises about 2 mg of iron per portion.

For the avoidance of doubt, when iron per se is stated as a mass amount it refers to the amount of iron as such in the product portion, not the iron source. For example, 2.1 mg of iron means 2.1 mg of the Fe ion, it does not mean 2.1 mg of FeNaEDTA.

### Colour Corrector

The product of the invention employs a colour correcting component to prevent the darkening and colour changes that can surprisingly be caused when FeNaEDTA is provided in a tea-based product. The invention employs di-basic NaPP for this purpose.

Di-basic NaPP has the CAS number 7758-16-9, the formula Na₂H₂P₂O₇, and the following structure:

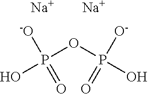

Synonyms of di-basic NaPP include: Disodium diphosphate; Disodium pytophosphate; Disodium dihydrogen pyrophosphate; Sodium acid pyrophosphate; and Sodium polyphosphate.

The product may comprise from 0.05 to 10% by dry weight of di-basic NaPP, more preferably from 0.1 to 7.5%, more preferably still from 0.2 to 5%, yet more preferably from 0.3 to 2.5%, yet more preferably still from 0.5 to 1%, most preferably from 0.8 to 0.9% by dry weight of di-basic NaPP.

The product may comprise from 1 to 100 mg of di-basic NaPP per portion, more preferably from 2.5 to 75 mg, more preferably still from 5 to 50 mg, yet more preferably from 7.5 to 30 mg, yet more preferably still from 10 to 25 mg, most preferably from 15 to 20 mg of di-basic NaPP per portion.

### Molar Ratio of Colour Corrector:Iron Source

The product may comprise a molar ratio of di-basic NaPP:FeNaEDTA of from 0.5:1 to 4:1, preferably from 0.75:1 to 3.5:1, more preferably from 1:1 to 3:1, more preferably still from 1.5:1 to 2.5:1, most preferably about 2:1.

As set out in the foregoing, the present invention has found that the use of the claimed combination of Iron Source and Colour Corrector is capable of correcting darkening and colour changes associated with iron fortified of tea-based beverages.

Darkness and Overall Colour Correction Factors

The colour and darkness of tea-based beverages can be expressed using the coordinates of the CIE 1976 L*a*b* colour space. CIE L*a*b* values can be measured by colourimetry according to the joint ISO/CIE standard (ISO 11664-4:2008(CE); CIE S 014-4/E:2007). Colour is expressed as three values:
L* for the lightness from black (0) to white (100),
a* from green (−) to red (+), and
b* from blue (−) to yellow (+).

Samples can be compared to one another to determine the difference in these values (ΔL*, Δa*, Δb*) and from these values, the total colour difference, Delta E* (ΔE*) can also be calculated.

It will be appreciated that the ΔL* and ΔE* values are of particular interest in the context of the present invention because they may be used to determine the darkness and colour respectively of a normal, un-fortified tea-based beverage and compare that to tea-based beverages containing various Iron Sources and Potential Colour correctors.

The present invention seeks to provide a product that delivers an iron-fortified tea-based beverage that utilises di-basic NaPP to correct the darkness and overall colour changes caused by FeNaEDTA such that the darkness and overall colour is as close as possible to the non-fortified tea-based beverage. This can be represented as “Darkness Correction Factor” (DCF) and Overall Colour Correction Factor” (OCCF) respectively.

DCF is calculated as:

DCF=L*ₛₐₘₚₗₑ−L*_{blank}
where L*ₛₐₘₚₗₑ is the L*ᵥₐₗᵤₑ of the fortified and colour corrected tea-based beverage obtained from the product according to the present invention; and
where L*_{blank} is the L*ᵥₐₗᵤₑ of the same tea product with only the tea component and no iron source or colour corrector.

Accordingly, the DCF value is preferably from −10 to 0, more preferably from −8 to 0, more preferably still from −6 to 0, yet more preferably from −4 to 0, most preferably from −2.5 to 0.

OCCF is calculated as:

OCCF=E*ₛₐₘₚₗₑ−E*_{blank}
where E*ₛₐₘₚₗₑ is the E*ᵥₐₗᵤₑ of the fortified and colour corrected tea-based beverage obtained from the product according to the present invention; and
where E*_{blank} is the E*ᵥₐₗᵤₑ of the same tea product with only the tea component and no iron source or colour corrector.

Accordingly, the OCCF value is preferably from 0 to 10, more preferably from 0 to 8, more preferably still from 0 to 6, yet more preferably from 0 to 4, most preferably from 0 to 2.5.

As used herein the term “comprising” encompasses the terms “consisting essentially of” and “consisting of”. All percentages and ratios contained herein are calculated by weight unless otherwise indicated. It should be noted that in specifying any range of values or amounts, any particular upper value or amount can be associated with any particular lower value or amount.

Except in the operative and comparative examples, all numbers in the description indicating amounts of materials, conditions of reaction, physical properties of materials, and/or use are to be understood as being preceded by the word “about”.

The various features of the embodiments of the present invention referred to in individual sections above apply, as appropriate, to other sections mutatis mutandis. Consequently, features specified in one section may be combined with features specified in other sections as appropriate. The disclosure of the invention as found herein is to be considered to cover all embodiments as found in the claims as being multiply dependent upon each other. Unless defined otherwise, all technical and scientific terms used herein have the same meaning as commonly understood by one of ordinary skill in the art in the field of tea processing.

The present invention will now be illustrated by reference to the following non-limiting examples.

### Examples

Various sources of iron were assessed for their impact on the colour and darkness of tea beverages. The ability of various compounds to correct these colour changes was also tested.

### Materials

The tea beverages tested were:
Black Tea teabags, Lipton Yellow label (purchased from Albert Hein supermarket, NL)
   Total amount of black tea: 2 g
Green Tea teabags, Lipton Greentea classic (purchased from Albert Hein supermarket, NL)
   Total amount of green tea: 2 g

The Iron Sources tested were:
FeNaEDTA (Trihydrate, CAS number 18154-32-0)
   Supplier: Dr. Paul Lohmann GmbH & Co. KGaA, Hauptstrasse 2, 31860 Emmerthal, Germany
Ferrous Fumarate (FeFu) (CAS number 141-01-5)
   Supplier: Aldrich, order number F5381, lot number SLBB5910V
FeSO₄ (Heptahydrate, CAS number 7782-63-0)
   Supplier: Sigma-Aldrich, product number 215422, lot number MKBS1888V

The Potential Colour Correctors tested were:
Di-basic NaPP (CAS number: 7758-16-9)
   Supplier: Innophos Canada Holdings (sodium acid pyrophosphate) Product name: BP Pyro
Tetra-basic NaPP (CAS Number: 7722-88-5)
   Supplier: Innophos Canada Holdings

### Sample Preparation

### Iron Sources—Stock Solutions:

For Iron Source solutions, 10 mg Fe/ml stock solutions were prepared using the Iron Sources listed above. The 10 mg Fe/ml solutions (equivalent to 0.169 mol/I) were prepared from the iron salts where:
FeNaEDTA was FeNaEDTA*3H₂O containing 15.2 wt % Fe
FeSO₄ was FeSO₄*7H₂O containing 20.1 wt % Fe, and
FeFu contained 32.9 wt % Fe.

### Potential Colour Correctors—Stock Solutions:

For Tetra-basic NaPP, 72 mg Tetra-NaPP/ml stock solutions were prepared.
For Di-basic NaPP, 59.4 Di-NaPP mg/ml stock solutions were prepared.

### Tea Beverages:

Green and Black Tea Beverages were prepared separately as follows:
200 ml of boiled milli-Q water was transferred to a plastic jar with the tea bag (green or black tea).
At the point of contact (water to tea bag) a timer was started, the bag was infused for 3 minutes.
After the 3 minute infusion, the tea bag was gently squeezed using a spoon, removed, and discarded.
Where used, aliquots of the stock solutions of Iron Sources and/or Potential Colour Correctors described above were stirred into the brewed Tea Beverage to provide the Test Combinations as described below and in Tables 1 & 2.
The brewed Tea Beverages were allowed to cool for 10 minutes.
The cooled Tea Beverages were stirred before colorimetric analysis as described below.

### Test Combinations:

Samples were prepared as shown in Tables 1 & 2. All samples contained 200 ml of the Tea Beverage solutions brewed from the 2 g of tea in the bags described above.

Where Iron Sources were added, stock solution was added in an amount that provided 9.5% of the aforementioned NRV of Iron—i.e. 2.1 mg of Iron (Fe) in the 200 ml Tea Beverage solution.

Where Potential Colour Correctors were used, stock solution was added in an amount to provide a molar ratio of 2.1:1 of Potential Colour Corrector:Iron Source. For those Test Combinations where no Iron Source was present, the amount of Potential Colour Corrector was added such that it would have been equivalent to a molar ratio of 2.1 relative to the 15% RDA of the Iron Source, if the Iron Source had actually been present.

Samples that contained both FeNaEDTA and dibasic NaPP contained:
13.8 mg (0.68% wt) FeNaEDTA*3H₂O per cup of tea, equivalent to 12 mg of FeNaEDTA anhydrous.
17.5 mg (0.86% wt) dibasic NaPP per cup of tea (Equivalent to 2.1 equimolar FeNaEDTA).

TABLE 1
Sample Preparation and Results of Colorimetric Analysis for Black Tea

| | | | Equivalent | | | | | |
|---|---|---|---|---|---|---|---|---|
| | | | Molar Ratio | | | Potential | | |
| Sample | | % NRV | Potential Colour | Tea | Iron | Colour | | |
| Name | pH | Fe | Corrector:Fe | Used | Source | Corrector | ΔE* | ΔL* |
| Black_1 | 4.8 | 9.5 | 2.1 | Black | FeNaEDTA | Di-basic NaPP | 2.2 | −2.1 |
| Black_Blank | 5.1 | 0 | n/a | Black | none | none | 0 | 0 |
| Black_A | 4.8 | 9.5 | n/a | Black | FeFu | none | 12.4 | −9.5 |
| Black_B | 4.8 | 9.5 | 2.1 | Black | FeFu | Di-basic NaPP | 5.8 | −3.3 |
| Black_C | 5.5 | 9.5 | 2.1 | Black | FeFu | Tetra-basic NaPP | 12 | −9.2 |
| Black_D | 5 | 9.5 | n/a | Black | FeNaEDTA | none | 6.1 | −5.1 |
| Black_E | 5.6 | 9.5 | 2.1 | Black | FeNaEDTA | Tetra-basic NaPP | 15.7 | −13.2 |
| Black_F | 4.5 | 9.5 | n/a | Black | FeSO4 | none | 37.7 | −27.9 |
| Black_G | 4.4 | 9.5 | 2.1 | Black | FeSO4 | Di-basic NaPP | 16.9 | −11.1 |
| Black_H | 4.7 | 0 | 2.1 | Black | none | Di-basic NaPP | 2.3 | 1.4 |
| Black_I | 5.7 | 0 | 2.1 | Black | none | Tetra-basic NaPP | 1.7 | −0.2 |
| Black_J | 5.3 | 9.5 | 2.1 | Black | FeSO4 | Tetra-basic NaPP | 39.1 | −29 |

TABLE 2
Sample Preparation and Results of Colorimetric Analysis for Green Tea

| | | | Equivalent | | | | | |
|---|---|---|---|---|---|---|---|---|
| | | | Molar Ratio | | | Potential | | |
| Sample | | % NRV | Potential Colour | Tea | Iron | Colour | | |
| Name | pH | Fe | Corrector:Fe | Used | Source | Corrector | ΔE* | ΔL* |
| Green_1 | 5 | 9.5 | 2.1 | Green | FeEDTA | Di-basic NaPP | 2.7 | −1.4 |
| Green_Blank | 5.4 | 0 | n/a | Green | none | none | 0 | 0 |
| Green_A | 5.1 | 9.5 | n/a | Green | FeFu | none | 6.4 | −5.7 |
| Green_B | 4.9 | 9.5 | 2.1 | Green | FeFu | Di-basic NaPP | 4.3 | −2.1 |
| Green_C | 6.1 | 9.5 | 2.1 | Green | FeFu | Tetra-basic NaPP | 8.3 | −8 |
| Green_D | 5.3 | 9.5 | n/a | Green | FeEDTA | none | 5.6 | −5.3 |
| Green_E | 5.9 | 9.5 | 2.1 | Green | FeEDTA | Tetra-basic NaPP | 15 | −14.5 |
| Green_F | 4.7 | 9.5 | n/a | Green | FeSO4 | none | 31 | −27.4 |
| Green_G | 4.7 | 9.5 | 2.1 | Green | FeSO4 | Di-basic NaPP | 12.4 | −9.4 |
| Green_H | 5.1 | 0 | 2.1 | Green | none | Di-basic NaPP | 3.5 | 0.7 |
| Green_I | 6.3 | 0 | 2.1 | Green | none | Tetra-basic NaPP | 6.3 | −1.3 |
| Green_J | 5.7 | 9.5 | 2.1 | Green | FeSO4 | Tetra-basic NaPP | 35.1 | −23.6 |

### Colorimetric Analysis

Aliquots of 20 ml of each of the Samples shown in Tables 1 & 2 were transferred to a quartz cuvette and CIE L*a*b* analysis was performed as follows.

The colours of the samples were measured using a Hunterlab Ultrascan VIS spectrophotometer (wavelength: 360-780 nm). For this work transmitted colour was measured.

The sensor used a plastic integrating sphere that was six inches (152.4 mm) in diameter and coated with Spectraflect™, to diffuse the light from the lamp. The light illuminated the sample and was transmitted through it. A lens was located at an angle of 8° from perpendicular to the sample surface. The lens collected the transmitted light and directed it to a diffraction grating which separated the light into its component wavelengths which were measured by dual diode arrays and converted into data.

The transmission compartment located in the middle of the sensor was used for measuring the transmitted colour of the liquids. The transmission compartment door was closed while standardizing and taking measurements. A transmission cell holder accommodated aliquots in 10 mm transmission cells. To install, the transmission cell holder was placed into the transmission compartment at the centre, widest part of the transmission compartment.

The transmission cell provided an optically clear glass cell with a fixed path length of 10 mm. Its dimensions were 55 mm×57 mm (width×height). The minimum sample volume for measurement was 20 ml. Measurements were done in total transmission mode (TTRAN). The cell was placed at the sphere opening at the front of the transmission compartment, inside the spectrophotometer.

### Measurements

The spectrophotometer was controlled by EasyMatch QC software which performed integration of transmittance values over the visible spectrum to arrive at tristimulus X, Y, and Z values. These values simulate the colour matching response functions of the human observer as defined by the 1931 2° Standard Observer or the 1964 CIE 10° Standard Observer (CIE XYZ).

### Instrument Settings

Sensor name: USVIS1666—Ultrascan VIS
ModeType: TTRAN—Total Transmission
Area View: 1 in.
UV filter position: UVF nominal

### Calculation of ΔE*, and ΔL*

Calculation of ΔE* and ΔL* made use of the L*a*b* values as calculated by the Hunterlab software.

Calculation Δa* and Δb*:

Δa*=a*ₛₐₘₚₗₑ−a*_{blank}

Δb*=b*ₛₐₘₚₗₑ−b*_{blank}

Calculation ΔL*:

ΔL*=L*ₛₐₘₚₗₑ−L*_{blank}

ΔL* indicates difference in lightness and darkness (+ΔL* means sample is lighter than the “blank” sample, −ΔL* means sample is darker than the “blank” sample)

Calculation ΔE*:

ΔE*=\sqrt{(ΔL*)²+(Δa*)²+(Δb*)²}

Deltas for L* (ΔL*), a* (Δa*) and b* (Δb*) indicate how much a sample and the “blank” sample differ from one another in L*, a* and b*. ΔL*, Δa* and Δb* may be positive (+) or negative (−). The total colour difference, Delta E* (ΔE*), however, is always positive.

### pH Measurement

25 ml of samples were aliquoted in a 50 ml tube, stored for 1-2 days in the refrigerator, pH was then measured (with an InLab Expert Pro electrode) in samples at approximately 16° C. with a pH meter (Mettler S20 SevenEasy pH) which corrected for temperature. The pH values are shown in Table 1.

### Visual Assessments

200 μl of each sample was transferred to a well of a 96-well plate and photos were taken.

### Results of Colorimetric Analysis

The results of the Colorimetric Analysis are provided in the final columns of Tables 1 & 2.
ΔE* shows the change in colour relative to the respective “blank” sample.
ΔL* shows whether the tea is showing darkening (negative figure) or lightening (positive figure) compared to the “blank” sample.

It can be seen that when used without a Potential Colour Corrector, all Iron Sources (FeFu, FeNaEDTA, FeSO₄) caused changes in colour and darkening (See results for Samples: Black_A, Black_D, Black_F, Green_A, Green_D, Green_F).

It can also be seen that when the Potential Colour Correctors were used without an Iron Source, all samples experienced some minor changes in colour and darkening (See results for Samples: Black_H, Black_I, Green_H, Green_I).

Crucially, it can be seen that only the di-basic NaPP proved to be effective at correcting the colour changes and darkening but only for one Iron Source—i.e. FeNaEDTA (See results for Samples: Black_1, and Green_1).

The inventors have therefore identified the unique ability of the combination of FeNaEDTA and di-basic NaPP to provide an iron fortified tea-based beverage that does not suffer from colour change or from darkening (irrespective of whether the tea is green or black).

1. A product comprising:
a) a tea component,
b) ethylenediaminetetraacetic acid, ferric-sodium salt (FeNaEDTA); and
c) di-basic sodium pyrophosphate (NaPP).

2. The product according to claim 1, wherein the product is a beverage precursor.

3. The product according to claim 1, wherein the tea component is derived from the plant Camellia sinensis.

4. The product according to claim 1, wherein the tea component is black tea.

5. The product according to claim 1, wherein the tea component is green tea.

6. The product according to claim 1, wherein the tea component is leaf tea.

7. The product according to claim 1, wherein the product comprises from 90 to 99.9% by dry weight of the tea component.

8. The product according to claim 1, wherein the product comprises from 0.05 to 10% by dry weight of FeNaEDTA.

9. The product according to claim 1, wherein the product comprises from 0.05 to 10% by dry weight of di-basic NaPP.

10. The product according to claim 1, wherein the product comprises a molar ratio of di-basic NaPP:FeNaEDTA of from 0.5:1 to 4:1.
